(19) United States
(12) Patent Application Publication
(10) Pub. No.: US 2026/0148731 A1
(43) Pub. Date: May 28, 2026

(54) METHOD AND APPARATUS FOR ENHANCING LANGUAGE MODEL-BASED TEXT-TO-SPEECH (TTS) WITH PREFERENCE ALIGNMENT ALGORITHMS

(71) Applicant: TENCENT AMERICA LLC, Palo Alto, CA (US)

(72) Inventors: Hao ZHANG, Columbus, OH (US); Dong YU, Palo Alto, CA (US)

(73) Assignee: TENCENT AMERICA LLC, Palo Alto, CA (US)

(21) Appl. No.: 18/961,822

(22) Filed: Nov. 27, 2024

(51) Int. Cl. G10L 13/027

(52) U.S. Cl. CPC G10L 13/027

(57) ABSTRACT

A method includes inputting an input text sequence into a language model to generate a plurality of speech samples; applying one or more preference models to the plurality of speech samples to generate a set of preferred samples and a set of non-preferred samples; applying direct performance improvement optimization to preference data associated with the set of preferred samples and the set of non-preferred samples to generate optimized samples; and training the language model based on the optimized samples.

### FIELD

The disclosure generally relates to the field of speech synthesis and natural language processing, specifically to text-to-speech (TTS) systems that leverage language models (LMs) for generating human-like speech.

### BACKGROUND

Text-to-speech (TTS) systems have long focused on synthesizing natural-sounding speech from text and, optionally, other non-text conditions. Historically, mainstream TTS models have operated in continuous space, relying on various deep learning techniques to generate high-quality audio. However, recent advancements in audio tokenization have shifted the paradigm, enabling TTS models to function effectively in discrete space. This discrete tokenization has facilitated the development of language model (LM)-based TTS systems, which have gained attention due to their simplified training and inference pipelines. LM-based TTS models learn the relationships between input text and output speech sequences more efficiently, making them capable of state-of-the-art performance by scaling up both the model size and the training data. Furthermore, these models have demonstrated remarkable zero-shot capabilities, such as speaker identity cloning and cross-lingual synthesis.

Despite these advancements, generating high-quality, natural-sounding speech that aligns with human preferences remains a challenge. Simply scaling up model size and training data is insufficient to ensure that the generated speech adheres to subjective human evaluations of quality and naturalness. Preference alignment (PA) is a set of algorithms widely used in text-based language models (LMs) to align model outputs with specific, often abstract, human preferences that are difficult to capture using traditional loss functions like cross-entropy. PA is typically framed as a reinforcement learning problem, where a reward model is trained to capture human preferences, and the language model is then optimized to maximize reward values. When the preferences are human-derived, this process is referred to as human feedback reinforcement learning (HFRL), which has become a common practice to ensure desirable model traits such as helpfulness, truthfulness, and harmlessness in text LMs.

### SUMMARY

According to one or more embodiments, a method performed by at least one processor includes inputting an input text sequence into a language model to generate a plurality of speech samples; applying one or more preference models to the plurality of speech samples to generate a set of preferred samples and a set of non-preferred samples; applying direct performance improvement optimization to preference data associated with the set of preferred samples and the set of non-preferred samples to generate optimized samples; and training the language model based on the optimized samples.

According to one or more embodiments, an apparatus includes: at least one memory configured to store program code; and at least one processor configured to read the program code and operate as instructed by the program code, the program code including: inputting code configured to cause the at least one processor to input an input text sequence into a language model to generate a plurality of speech samples; first applying code configured to cause the at least one processor to apply one or more preference models to the plurality of speech samples to generate a set of preferred samples and a set of non-preferred samples; second applying code configured to cause the at least one processor to apply direct performance improvement optimization to preference data associated with the set of preferred samples and the set of non-preferred samples to generate optimized samples; and training code configured to cause the at least one processor to train the language model based on the optimized samples.

According to one or more embodiments, a non-transitory computer readable medium having instructions stored therein, which when executed by a processor cause the processor to execute a method includes: inputting an input text sequence into a language model to generate a plurality of speech samples; applying one or more preference models to the plurality of speech samples to generate a set of preferred samples and a set of non-preferred samples; applying direct performance improvement optimization to preference data associated with the set of preferred samples and the set of non-preferred samples to generate optimized samples; and training the language model based on the optimized samples.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1, according to embodiments.

FIG. 3 is a flowchart of an example process for training a language model, according to embodiments.

FIG. 4 is a block diagram of an example architecture for training a language model, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to an enhanced method for text-to-speech (TTS) synthesis by applying preference alignment (PA) techniques to language model (LM)-based TTS systems. The embodiments focus on leveraging Direct Preference Optimization (DPO) to align the outputs of an LM-based TTS model with human preferences across several speech quality metrics, including intelligibility, speaker similarity, and proxy subjective evaluation scores.

The embodiments build upon recent advancements in LM-based TTS systems, which operate in discrete space due to the availability of high-quality audio tokenization methods. These LM-based systems have simplified training and inference processes, enabling them to scale efficiently with larger models and more extensive datasets. However, despite their promising performance, these models often fail to fully align with human perception without further optimization.

The embodiments of the present disclosure provide a robust framework for applying preference alignment (PA) to TTS. By utilizing DPO, the embodiments advantageously simplify the preference alignment process, allowing the model to be directly optimized towards human-desired outcomes without the need for complex reward modeling. The embodiments have been shown to improve intelligibility and speaker similarity, with some evaluations even surpassing human speech in terms of subjective quality.

In contrast to text-based LMs, PA techniques have not been extensively explored in the TTS domain, particularly for LM-based systems. Previous works, such as SpeechAlign, applied multiple PA methods to LM-based TTS but only used ground truth as positive examples. UNO 3 optimized TTS models using unpaired preference data and incorporated uncertainty in subjective evaluation, while RIO applied Bayesian principles to select preference data for optimization. In industrial applications, models such as SeedTTS have adopted methods like Direct Preference Optimization (DPO) and Proximal Policy Optimization (PPO) to align TTS systems with human preferences. DPO has also been employed in other audio tasks, such as diffusion-based text-to-audio systems in TANGO2.

Building upon these findings, this invention seeks to apply a PA objective, specifically Direct Preference Optimization (DPO), to LM-based TTS models to improve speech quality across multiple metrics, including intelligibility, speaker similarity, and subjective evaluations.

The embodiments of the present disclosure provide an application of Direct Preference Optimization (DPO) to TTS models, enabling the embodiments to generate speech that aligns with human preferences across multiple dimensions.

The embodiments provide a comprehensive approach addressing practical issues such as preference pair selection, hyper-parameter tuning, and metric selection to ensure the optimal performance of TTS systems in both in-domain and out-of-domain tasks. The embodiments Demonstration of the efficacy of preference alignment in low-resource scenarios, showing that significant improvements can be achieved with as little as one hour of training data. The embodiments provide empirical validation that preference alignment can enhance TTS models in out-of-domain scenarios, thereby generalizing effectively to new tasks and applications. The embodiments advantageously produce high-quality, human-like speech that surpasses existing TTS systems, while maintaining practical, scalable implementations suitable for a wide range of applications, including voice assistants, multimedia content creation, and accessibility technologies.

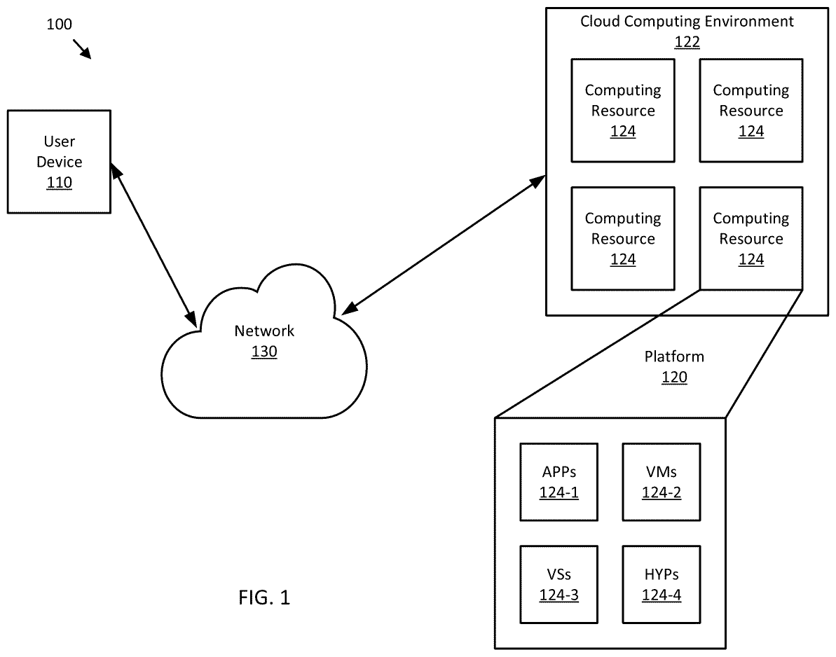

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

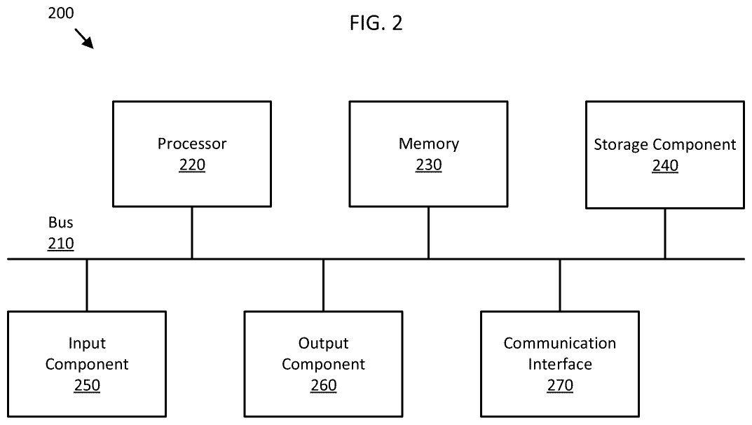

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

The embodiments of the present disclosure appli Preference Alignment (PA) techniques to Language Model-Based Text-to-Speech (LM-based TTS) systems, improving speech synthesis quality by aligning the model outputs with human preferences. This invention uses Direct Preference Optimization (DPO) to fine-tune the LM-based TTS models, enhancing intelligibility, speaker similarity, and subjective evaluation scores. The invention further demonstrates how preference alignment can be effectively implemented even in low-resource scenarios and how it generalizes well to out-of-domain applications.

According to embodiments, TTS is a conditional generation task that generates speech signal y based on the given conditions x, such as input text string s and other non-textual cues. In one or more examples, it is assumed that a short clip from the same speaker of y, (e.g., y_{ref}) is the only non-textual cue, from which features like speaker identity and prosody can be imitated. Thus, the training objective of TTS is to maximize the posterior:

$${max}_{θ} {P}_{θ} ( y \vert x ) = {max}_{θ} {P}_{θ} ( y \vert s , {y}_{ref} ) , \qquad Eq . ( 1 )$$

where θ is the trainable parameter of the model.

In the context of discrete space modeling, particularly LM-based TTS, all audio y, y_{ref} may be converted into discrete codes by audio codec encoding, s.t., y^{d}, y^{d}_{ref}. Text input s may also be tokenized into a integer vector s^{d}. By splicing s^{d} with y^{d}_{ref} and y^{d}, the example sequence [s^{d}, y^{d}_{ref}, y^{d}] is formed and then learned by a language model. Cross-entropy loss is applied to y^{d} so that the posterior P_{θ}(y^{d}/s^{d}, y^{d}_{ref}) is maximized. During inference, the predicted sequence ŷ^{d} is first generated by an LM, and then the output speech ŷ can be reconstructed from it using audio codec decoding.

Usually, audio codec models tokenized each frame of audio into n_{q} codes (n_{q}^{ref}>1), which makes the example sequence [s^{d}, y^{d}, y^{d}]∈Z^{T×nq} a two-dimensional sequence¹. T stands for number of frames. As standard LMs work_{ref} with one-dimensional sequence, modeling the sequences with the extra n_{q}-dimension is non-trivial. The embodiments may use a Multi-Scale Transformer as the model architecture, which first uses a global Transformer to predict an embedding for each audio frame; and then a local Transformer predicts the n_{q} codes sequentially based on each frame embedding. Both global and local Transformers may be causal. Like standard LM, Multi-Scale Transformer also predicts the code-level posterior for each audio code within each frame, which is then used in loss computing (e.g., cross-entropy) and model inference. In one or more examples, the conditional sequence is re-named as x=[s^{d}, y^{d}] and the target sequence y=[y^{d}], both are in discrete space.

Although LM-based TTS models are typically trained to maximize the posterior of the target sequence yy, higher posterior probabilities do not always lead to more preferred or natural-sounding speech from a human perception standpoint. According to one or more embodiments, Preference Alignment (PA) is introduced as a solution to directly optimize the language model toward generating content that aligns with human preferences. PA is usually described as a reinforcement learning problem. For example, assume there is a latent reward model r*(x, y) that represents the preferences by a scalar reward, higher means more preferred. Thus, with the given reward model, the optimization objective is to guide the LM to pursue a higher expected reward:

$${max}_{θ} {𝔼}_{y \sim {P}_{θ} ( y \vert x )} [ r ( x , y ) ] - β \cdot {𝔻}_{KL} [ {P}_{θ} ( y \vert x ) \vert \vert {P}_{ref} ( y \vert x ) ] , \qquad Eq . ( 2 )$$

where the latter term is a KL-divergence constraint to avoid the LM P_{θ} drifting too far away from a reference model P_{ref}. β is a hyper-parameter, larger means stronger constraint. The choice of β is explained in further detail below. In one or more examples, the reference model P_{ref} is initialized identically with P_{θ} and is frozen during training.

Conventionally, the optimization in Eq. (2) works with an explicit reward model. As the latent reward model is usually unavailable, a proxy reward model r_{φ}(x, y) is first built from the preference dataset instead. Subsequently, the optimization is conducted using proximal policy optimization (PPO). This workflow is complicated and PPO sometimes encounters instability issues in training. Recent advances in PA demonstrate that, under certain circumstances, the optimization in Eq. (2) can be solved in close form without building an explicit reward model. A representative approach is Direct Preference Optimization (DPO).

In one or more examples, DPO deals with a special case where the preference data is win-lose pairs: with the same conditions x, the probability of yw being more preferred than sequence yl follows Bradley-Terry model as follows:

$$P ( {y}_{w} > {y}_{l} \vert x ) = \frac{exp ( {r}^{*} ( x , {y}_{w} ) )}{exp ( {r}^{*} ( x , {y}_{w} ) ) + exp ( {r}^{*} ( x , {y}_{l} ) )} \qquad Eq . ( 3 )$$

Therefore, with the known preference data triplets (x, y_{w}, yₗ), an explicit proxy reward model rφ can be trained by maximum-a-likelihood criterion, with σ being the sigmoid function:

$${max}_{{r}_{ϕ}} {𝔼}_{x , {y}_{w} , {y}_{l}} [ log σ ( {r}_{ϕ} ( x , {y}_{w} ) - {r}_{ϕ} ( x , {y}_{l} ) ) ] \qquad Eq . ( 4 )$$

Furthermore, it has been proven that, in Eq. (2), the LM P_{θ}(y/x) becomes optimal if an only if:

$${r}_{ϕ} ( x , {y}_{w} , {y}_{l} ) = β \cdot \frac{{P}_{θ} ( y \vert x )}{{P}_{ref} ( y \vert x )} + β \cdot ℤ ( x ) , \qquad Eq . ( 5 )$$

where Z(x) is termed as partition function that is independent of the generation target y.

Finally, substituting Eq. (5) into Eq. (4) excludes the reward model r_{φ}(x, y); training the explicit reward models is then transformed as direct optimization over the LM P_{θ}(y/x):

$${L}_{DPO} = {max}_{θ} 𝔼 [ log σ ( β \cdot log \frac{{P}_{θ} ( {y}_{w} \vert x )}{{P}_{ref} ( {y}_{w} \vert x )} - β \cdot log \frac{{P}_{θ} ( {y}_{l} \vert x )}{{P}_{ref} ( {y}_{l} \vert x )} ) ] \qquad Eq . ( 6 )$$

In one or more examples, DPO training starts from a baseline LM-based TTS model pre-trained with cross-entropy loss. Specifically, any posterior P (y/x) in Eq. (6) may be computed by flattening the two-dimensional y into row-first sequence and then summing the code-level log-posterior in auto-regressive format. To align with human perception, it would be ideal if the preference data pairs (x, y_{w}, yₗ) can come from human labelers. Instead, the embodiments adopt several pre-trained metric models as the proxy of real human preferences. With the same condition x, utterances are first scored by these models; the utterances with better/worse scores are set to y_{w} and yₗ, respectively. These metric models may be either generated from the LM or from natural speech.

In one or more examples, data, task setup, and tokenization may be set up as follows. The baseline model may be built with LibriSpeech, GigaSpeech, and the English part of Multilingual LibriSpeech, summing up to around 55 k hours. In one or more examples, speaker IDs may always be available for all datasets and may be used to select a 3-second speech clip from the same speaker2. All input text may be tokenized into phone sequences by g2p-en3 before language modeling. Reproduced SoundStream model may be adopted for audio tokenization, which may be configured as 50 frames per second and 8 codes per frame, e.g., nq=8.

In one or more examples, Multi-Scale Transformer may be adopted as the model architecture. The global Transformer may have 25 layers, each of which has an attention size of 1600, a feedforward size of 6400, and 25 attention heads. Those numbers for the local Transformer may be {6, 384, 1536, 6}, respectively. The total trainable parameters may be 1.15B.

Training and Inference: The baseline model may be updated by 1M steps with the global batch size of around 80 k frames. AdamW optimizer with a peak learning rate of 2e-4 may be adopted, with 70 k warmup steps, and then decays exponentially. Training may be based on 8×A100-40 G GPUs. For inference, top-k sampling using k=30 may be used; the logits may be re-scaled with a temperature of 1.2. For each example, batch inference may be performed with the size of 10 using the same condition (e.g., text and reference speech clips). Human prior in the selection of reference speech clips is not introduced as they are usually provided by users.

In one or more examples, for the LM-based TTS system, three metrics of the generated content may be used: intelligibility (WER), speaker similarity (SPK SIM), and proxy subjective evaluation scores (Proxy MOS). The specific models for each metric may be: Whisper-large for WER; Speaker embeddings from RawNet, for SPK SIM; UTMOS for Proxy MOS. These metric models may also be used in most evaluations. We use additional metric models to ensure the TTS model is improved in general rather than over-fits to the preference of these pre-trained metric models. In one or more examples, LibriSpeech Test-Clean may be adopted in most evaluations while VCTK

Although re-ranking among the batch-generated examples can significantly improve the performance, the embodiments may not use that operation and may report every number as the average of all 10 examples.

The embodiments of the present disclosure introduce a novel approach to improving Language Model-Based Text-to-Speech (LM-based TTS) systems by incorporating preference alignment (PA) methods. By applying Direct Preference Optimization (DPO), the embodiments significantly enhances the performance of TTS systems, enabling them to generate speech that surpasses ground truth human recordings in critical metrics such as speaker similarity and proxy subjective evaluation scores.

The embodiments thoroughly explore various factors influencing the success of preference alignment in LM-based TTS, addressing practical challenges such as preference pair selection, hyper-parameter tuning, and generalization to out-of-domain scenarios. Through experimentation, the embodiments demonstrate that preference alignment not only improves intelligibility and speaker similarity but also generalizes effectively with minimal training data.

The embodiments mark a substantial step forward in the application of preference alignment to TTS systems, providing a robust framework for aligning machine-generated speech with human preferences while ensuring high-quality, natural-sounding audio output. The outcomes of the embodiments set the stage for future advancements in TTS technology, with potential applications in multimedia, voice assistants, and accessibility tools.

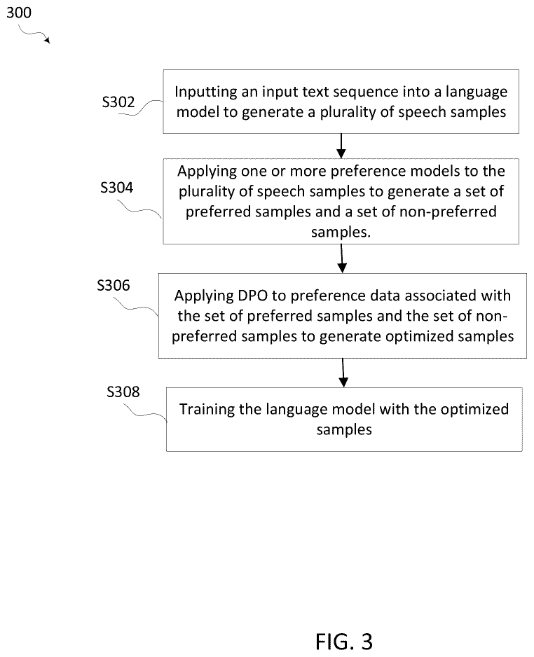

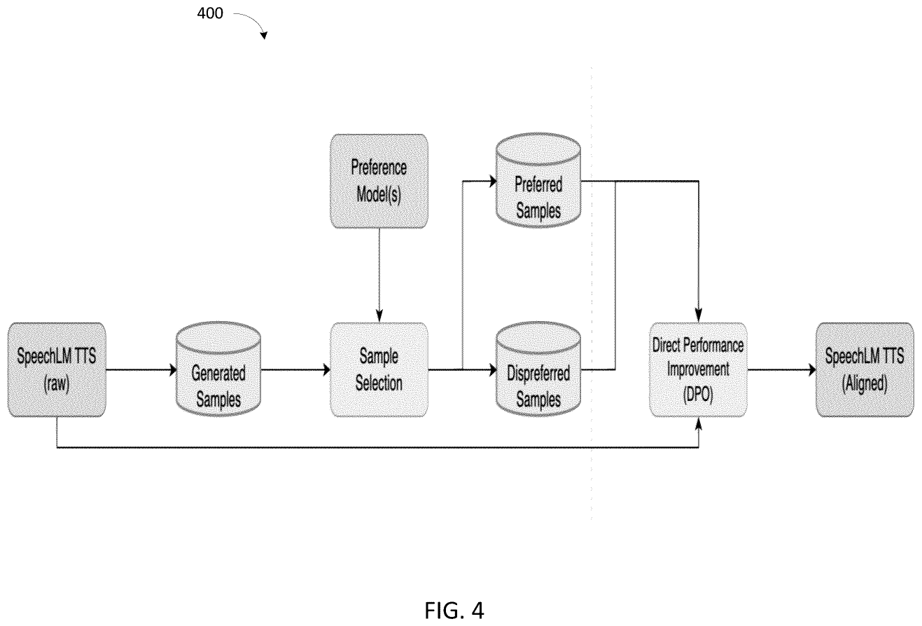

FIG. 3 illustrates a flowchart of an example process 300 for training a language model, in accordance with one or more embodiments. The process 400 may be implemented by processor 220 (FIG. 2). The process 300 illustrated in FIG. 3 is described with respect to the architecture illustrated in FIG. 4.

The process 300 may start at operation S302 where an input text sequence is input into a language model to generate a plurality of speech samples. For example, referring to FIG. 4, an input text sequence may be input into the SpeechLM TTS N different times to generate the plurality of speech samples. The SpeechLM TTS may be untrained or unaligned (e.g., raw).

The process proceeds to operation S304 where one or more preference models are applied to the plurality of speech samples to generate a set of preferred samples and a set of non-preferred samples. For example, referring to FIG. 4, the preference models are applied to the generated samples, where based on a score, the sample is selected as one of a preferred sample or a non-preferred sample (e.g., Dispreferred sample). The score may be compared to a threshold, where if the score is above a threshold, the sample is a preferred sample, and if the score is below or equal to the threshold, the sample is a non-preferred sample.

The process proceeds to operation S306 where DPO is applied to preference data associated with the set of preferred samples and the set of non0preferred samples to generate optimized samples. For example the preference data may include a sample from the set of non-preferred samples and a sample from the set of preferred samples.

The process proceeds to operation S308 where the language model is trained with the optimized samples. For example, referring to FIG. 4, the output of the DPO is used to train SpeechLM TTS such that the SpeechLM TTS is aligned with one or more preferences.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
inputting an input text sequence into a language model to generate a plurality of speech samples;
applying one or more preference models to the plurality of speech samples to generate a set of preferred samples and a set of non-preferred samples;
applying direct performance improvement optimization to preference data associated with the set of preferred samples and the set of non-preferred samples to generate optimized samples; and
training the language model based on the optimized samples.

2. The method according to claim 1, wherein the one or more preference models score each sample from the generated samples, wherein each sample above a threshold is assigned to the set of preferred samples, and each sample below or equal to the threshold is assigned to the set of non-preferred models.

3. The method according to claim 1, wherein each speech sample comprises a condition sequence that includes a tokenized input sequence and a corresponding tokenized target sequence.

4. The method according to claim 3, wherein the preference data is a data triplet is formed based on the condition sequence, at least one preferred sample from the set of preferred samples, and at least one non-preferred sample from the set of non-preferred samples.

5. The method according to claim 1, wherein the one or more preference models are pre-trained in accordance with one or more alignment metrics comprising intelligibility, speaker similarity, and evaluation scores.

6. The method according to claim 1, wherein the language model is a large language model.

7. The method according to claim 1, wherein the plurality of speech samples are generated by inputting the input text sequence into the language model N different times, wherein N is an integer greater than 0.

8. An apparatus comprising:
at least one memory configured to store program code; and
at least one processor configured to read the program code and operate as instructed by the program code, the program code including:
inputting code configured to cause the at least one processor to input an input text sequence into a language model to generate a plurality of speech samples;
first applying code configured to cause the at least one processor to apply one or more preference models to the plurality of speech samples to generate a set of preferred samples and a set of non-preferred samples;
second applying code configured to cause the at least one processor to apply direct performance improvement optimization to preference data associated with the set of preferred samples and the set of non-preferred samples to generate optimized samples; and
training code configured to cause the at least one processor to train the language model based on the optimized samples.

9. The apparatus according to claim 8, wherein the one or more preference models score each sample from the generated samples, wherein each sample above a threshold is assigned to the set of preferred samples, and each sample below or equal to the threshold is assigned to the set of non-preferred models.

10. The apparatus according to claim 8, wherein each speech sample comprises a condition sequence that includes a tokenized input sequence and a corresponding tokenized target sequence.

11. The apparatus according to claim 10, wherein the preference data is a data triplet is formed based on the condition sequence, at least one preferred sample from the set of preferred samples, and at least one non-preferred sample from the set of non-preferred samples.

12. The apparatus according to claim 8, wherein the one or more preference models are pre-trained in accordance with one or more alignment metrics comprising intelligibility, speaker similarity, and evaluation scores.

13. The apparatus according to claim 8, wherein the language model is a large language model.

14. The apparatus according to claim 8, wherein the plurality of speech samples are generated by inputting the input text sequence into the language model N different times, wherein N is an integer greater than 0.

15. A non-transitory computer readable medium having instructions stored therein, which when executed by a processor cause the processor to execute a method comprising:
inputting an input text sequence into a language model to generate a plurality of speech samples;
applying one or more preference models to the plurality of speech samples to generate a set of preferred samples and a set of non-preferred samples;
applying direct performance improvement optimization to preference data associated with the set of preferred samples and the set of non-preferred samples to generate optimized samples; and
training the language model based on the optimized samples.

16. The non-transitory computer readable medium according to claim 15, wherein the one or more preference models score each sample from the generated samples, wherein each sample above a threshold is assigned to the set of preferred samples, and each sample below or equal to the threshold is assigned to the set of non-preferred models.

17. The non-transitory computer readable medium according to claim 15, wherein each speech sample comprises a condition sequence that includes a tokenized input sequence and a corresponding tokenized target sequence.

18. The non-transitory computer readable medium according to claim 17, wherein the preference data is a data triplet is formed based on the condition sequence, at least one preferred sample from the set of preferred samples, and at least one non-preferred sample from the set of non-preferred samples.

19. The non-transitory computer readable medium according to claim 15, wherein the one or more preference models are pre-trained in accordance with one or more alignment metrics comprising intelligibility, speaker similarity, and evaluation scores.

20. The non-transitory computer readable medium according to claim 15, wherein the language model is a large language model.
